(19) United States
(12) Patent Application Publication
(10) Pub. No.: US 2013/0124180 A1
(43) Pub. Date: May 16, 2013

(54) METHOD AND APPARATUS FOR AUTOMATICALLY ARRANGING BUILDING ENERGY CONTROL SENSORS BASED ON INSTALLATION EXPENSE

(71) Applicant: Electronics and Telecommunications Research Institute, Daejeon (KR)

(72) Inventors: Jong Won KIM, Daejeon (KR); Youn Kwae JEONG, Daejeon (KR); Il Woo LEE, Daejeon (KR)

(73) Assignee: Electronics and Telecommunications Research Institute, Daejeon (KR)

(21) Appl. No.: 13/673,134

(22) Filed: Nov. 9, 2012

(30) Foreign Application Priority Data
Nov. 10, 2011 (KR) 10-2011-0117087

(51) Int. Cl. G06F 17/50

(52) U.S. Cl. CPC G06F 17/5009
USPC 703/13

(57) ABSTRACT

An apparatus automatically arranges a plurality of building energy control sensors based on installation expense. The apparatus includes an input module configured to receive building information, floor information of the building, structural information of rooms and a corridor for each floor of the building, and information on installation expense for one or more energy control sensors to be installed in the building. A sensor arrangement simulation module determines arrangement coordinates of each sensor on the basis of the installation expense information for each sensors to be installed in the building, and an out module outputs the determined arrangement coordinates of each control sensor.

### RELATED APPLICATION(S)

This application claims the benefit of Korean Patent Application No. 10-2011-0117087, filed on Nov. 10, 2011, which is hereby incorporated by reference as if fully set forth herein.

### FIELD OF THE INVENTION

The present invention relates to a building energy management system, and more particularly, to an apparatus and method for automatically arranging a plurality of energy control sensors in a building based on installation expense.

### BACKGROUND OF THE INVENTION

A wireless sensor network, which collects and analyzes detailed information through a plurality of control points installed in various field equipment and manages various sensors for maintaining a pleasant office environment and reducing energy consumption in an automatic control scheme, is generally established in buildings such as office buildings, for optimally managing building facilities and saving energy.

However, a conventional wireless sensor network system is capable of including only a plurality of sensor nodes, a gateway, and a server that are restrictively applied to the wireless sensor network, and cannot be applied to wired/wireless networks other than the wireless sensor network.

### SUMMARY OF THE INVENTION

In view of the above, the present invention provides an apparatus and method for automatically arranging a plurality of building energy control sensors based on installation expense, in a building energy management system.

In accordance with a first aspect of the present invention, there is provided an apparatus for automatically arranging a plurality of building energy control sensors based on installation expense, the apparatus including: an input module configured to receive building information, floor information of the building, structural information of rooms and a corridor for each floor of the building, and information on installation expense for one or more energy control sensors to be installed in the building; a sensor arrangement simulation module configured to determine arrangement coordinates of each sensor on the basis of the installation expense information for each sensors to be installed in the building; and an out module configured to output the determined arrangement coordinates of each control sensor.

In an exemplary embodiment of the apparatus, the input module includes: a building information unit configured to store the building information and information on sizes and shapes of the floor, room, and corridor of the building; a floor information unit configured to store information on floors of the building; a structure information unit configured to store information on room and corridor in each floors of the building, on the basis of the information on the floors; and a distribution unit configured to selectively provide sensor simulation starting signals and sensor installation expense information to the sensor arrangement simulation module in response to information on one or more energy control sensors to be installed on the basis of the information, stored in the floor information unit and the structure information unit, on the floor, room, and corridor of the building, so that the sensor arrangement simulation module calculates the arrangement coordinates and installation expense based on the sensor installation expense for each energy control sensors to be installed.

In an exemplary embodiment of the apparatus, the sensor arrangement simulation module includes: an installation expense calculation unit configured to receive a simulation starting signal to calculate installation expense of each energy control sensor to be installed, on the basis of the installation expense information for each energy control sensor; a unit sum calculation unit configured to calculate a unit sum of each energy control sensor; a quantity calculation unit configured to calculate a quantity of energy control sensors to be installed in the building, on the basis of the unit sum and the installation expense; a reference area calculation unit configured to calculate a reference area of each sensor on the basis of the calculated quantity of sensors; and an arrangement unit configured to calculate an arrangement position of each sensor, on the basis of information on the quantity of sensors and the information on the reference area.

In an exemplary embodiment of the apparatus, the reference area calculation unit calculates the reference area that each sensor covers, on the basis of the information on the quantity of sensors and the area information on the room and corridor information of the building.

In an exemplary embodiment of the apparatus, each of the energy control sensors include a temperature sensor, a humidity sensor, a temperature-humidity sensor, an illumination sensor, an occupancy sensor, a CO₂ sensor, or a fine dust sensor.

In accordance with a first aspect of the present invention, there is provided a method of automatically arranging a plurality of building energy control sensors based on installation expense, the method including: providing building information, floor information of the building, structural information of rooms and a corridor for each floor of the building; providing installation expense information for each sensor to be installed in the building; calculating arrangement coordinates of each sensor on the basis of the installation expense information; and outputting information on the calculated arrangement coordinates of each sensor in the building.

In an exemplary embodiment, the method further includes: storing information on floors of the building; and storing the structural information on sizes and shapes of the room and corridor for each floor of the building.

In an exemplary embodiment of the method, the providing installation expense information includes: providing information on the energy control sensors to be installed in the room and corridor of each floor on the basis of the information on the floor, room, and corridor of the building; and providing information on installation expense that is expended in installing the energy control sensors.

In an exemplary embodiment of the method, the calculating arrangement coordinates includes: calculating, in response to a simulation starting signal, an installation expense of each sensor, on the basis of the installation expense information for each sensor; calculating a unit sum of each sensor; calculating quantity of sensors to be installed in the building, on the basis of the unit sum and the installation expense of each sensor; calculating a reference area of each sensor on the basis of the calculated number of sensors; and calculating an arrangement position of each sensor in the building, on the basis of information on the number of sensors and the information on the reference area.

In an exemplary embodiment of the method, the calculating a reference area comprises calculating the reference area that each sensor covers, on the basis of the information on the quantity of sensors and the area information on the room and corridor information of the building.

In an exemplary embodiment of the method, each of the energy control sensors include a temperature sensor, a humidity sensor, a temperature-humidity sensor, an illumination sensor, an occupancy sensor, a CO₂ sensor, or a fine dust sensor.

### BRIEF DESCRIPTION OF THE DRAWINGS

The above and other objects and features of the present invention will become apparent from the following description of embodiments given in conjunction with the accompanying drawings, in which:

FIGS. 1A and 1B illustrate a block diagram of an apparatus for automatically arranging building energy control sensors based on installation expense in accordance with an embodiment of the present invention;

FIG. 2 illustrates a detailed block diagram of the input module 11 shown in FIG. 1A in accordance with an embodiment of the present invention;

FIG. 3 illustrates a detailed block diagram of the temperature sensor arrangement simulator 12 shown in FIG. 1A in accordance with an embodiment of the present invention;

FIG. 4 is a detailed block diagram of the humidity sensor arrangement simulator shown in FIG. 1A in accordance with an embodiment of the present invention;

FIG. 5 is a detailed block diagram of the temperature-humidity sensor arrangement simulator shown in FIG. 1A in accordance with an embodiment of the present invention;

FIG. 6 is a detailed block diagram of the illumination sensor arrangement simulator shown in FIG. 1A in accordance with an embodiment of the present invention;

FIG. 7 is a detailed block diagram of the occupancy sensor arrangement simulator shown in FIG. 1A in accordance with an embodiment of the present invention;

FIG. 8 is a detailed block diagram of the CO₂ sensor arrangement simulator shown in FIG. 1A in accordance with an embodiment of the present invention; and

FIG. 9 is a detailed block diagram of the fine dust sensor arrangement simulator shown in FIG. 1A in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

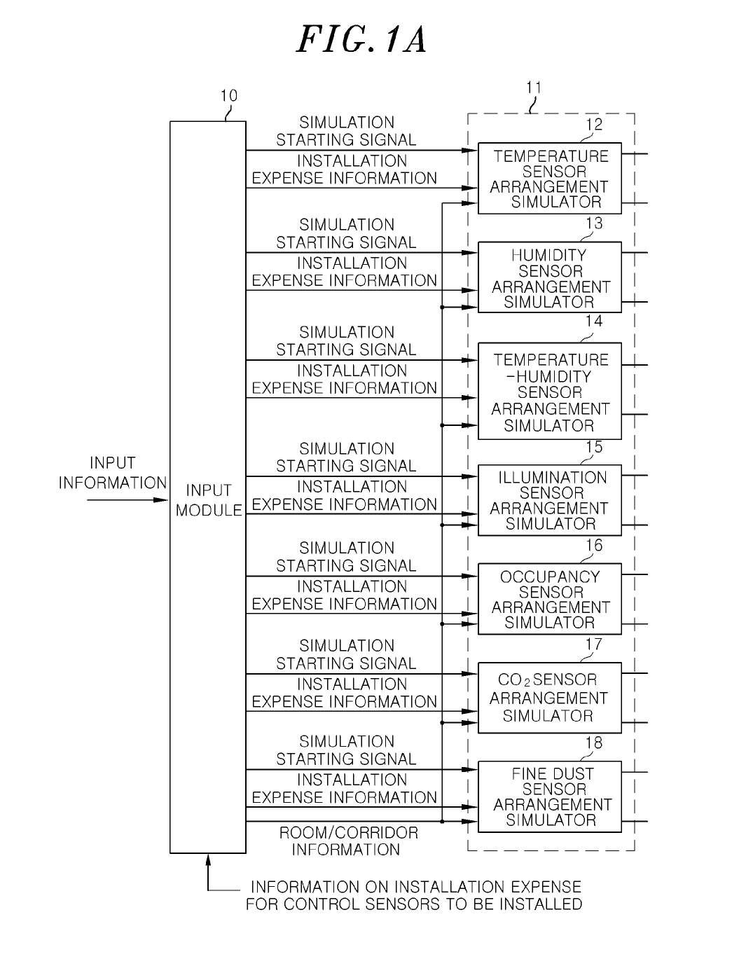

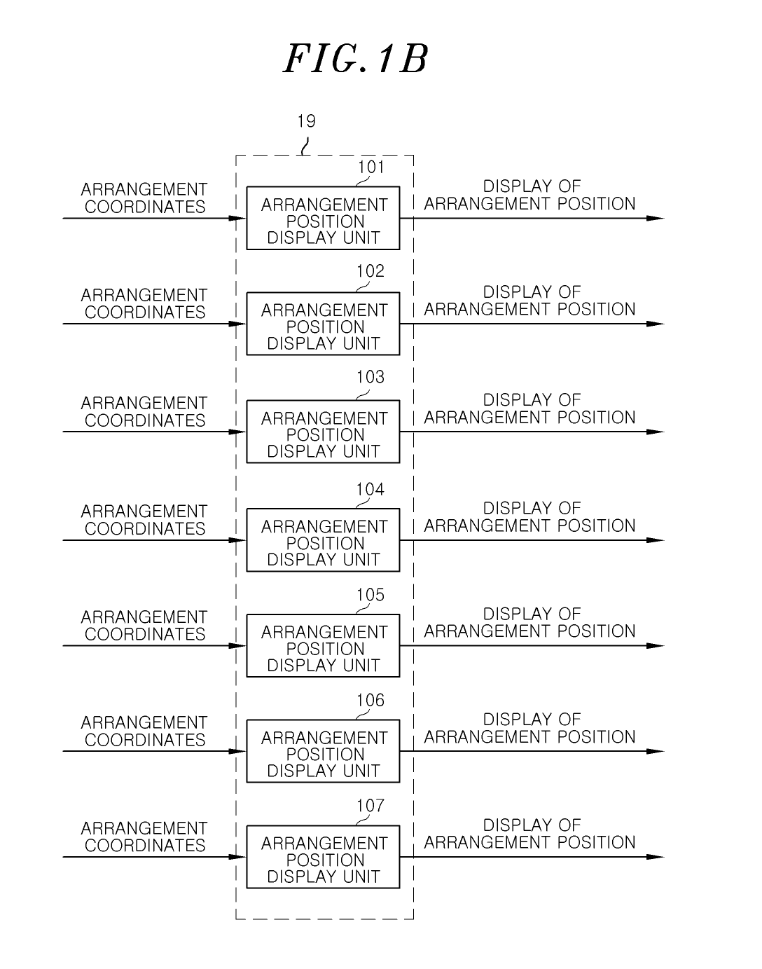

FIGS. 1A and 1B illustrate a block diagram of an apparatus for automatically arranging building energy control sensors based on installation expense in accordance with an embodiment of the present invention.

The apparatus includes an input module 10, a sensor-installation simulation module 11, and an output module 19. The input module 11 receives input information on a building, floors, room sizes, corridor sizes, room shapes, and corridor shapes and information on the installation expenses for temperature sensors, humidity sensors, temperature-humidity sensors, illumination sensors, occupancy sensors, CO₂ sensors, and fine dust sensors to be installed in the building from a user or a computer. The building information, the floor information, the room information, and the corridor information are then stored in the input module 10. Further, the input module 10 provides sensor simulation starting signals for one or more energy control sensors to be installed to the sensor arrangement simulation module 11 in order for simulating optimal arrangement for the energy sensors to be installed in the building based on installation expenses of the energy control sensors. The sensor arrangement simulation module 11 includes a temperature sensor simulator 12, a humidity sensor simulator 13, a temperature-humidity sensor simulator 14, an illumination sensor simulator 15, an occupancy sensor simulator 16, a CO₂ sensor simulator 17, and a fine dust sensor simulator 18 for the energy control sensors to be installed.

More specifically, the input module 10 provides a humidity-sensor simulation starting signal to a humidity sensor arrangement simulator 13, along with and information on a humidity-sensor installation expense and the room/corridor information.

Further, the input module 10 provides a temperature-humidity sensor simulation starting signal to a temperature-humidity sensor arrangement simulator 14, along with information on a temperature-humidity sensor installation expense and the room/corridor information; provides an illumination sensor simulation starting signal to an illumination sensor arrangement simulator 15, along with information on an illumination-sensor installation expense and the room/corridor information.

Moreover, the input module 10 provides an occupancy sensor simulation starting signal to an occupancy sensor arrangement simulator 16, along with information on an occupancy-sensor installation expense and the room/corridor information; provides a CO₂ sensor simulation starting signal to a CO₂ sensor arrangement simulator 17, along with information on a CO₂ sensor installation expense and the room/corridor information; and provides a fine dust sensor simulation starting signal to a fine dust sensor arrangement simulator 18, along with information on a fine dust sensor installation expense and the room/corridor information.

The temperature sensor arrangement simulator 12, in response to the temperature sensor simulation starting signal, the temperature-sensor installation expense, and the room/corridor information from the input module 10, calculates the number of temperature sensors to be installed on the basis of the temperature sensor installation expense and a temperature sensor unit sum, and calculates arrangement coordinates of the temperature sensors in a two-dimensional (2D) or three-dimensional (3D) space based on the temperature sensor installation expense. The arrangement coordinates of the temperature sensors is then transferred to the out module 19.

The humidity sensor arrangement simulator 13, in response to the humidity sensor simulation starting signal, the humidity sensor installation expense, and the room/corridor information from the input module 10, calculates the number of humidity sensors to be installed on the basis of the humidity sensor installation expense and a humidity sensor unit sum, and calculates arrangement coordinates of the humidity sensors in the 2D or 3D space based on the humidity sensor installation expense. The arrangement coordinates of the humidity sensor is then transferred to the out module 19.

The temperature-humidity sensor arrangement simulator 14, in response to the temperature-humidity sensor simulation starting signal, the temperature-humidity sensor installation expense, and the room/corridor information from the input module 10, calculates the number of temperature-humidity sensors to be installed on the basis of the temperature-humidity sensor installation expense and a temperature-humidity sensor unit sum, and calculates arrangement coordinates of the temperature-humidity sensors based on the temperature-humidity sensor installation expense in the 2D or 3D space. The arrangement coordinates of the temperature-humidity sensors is then transferred to the out module 19.

The illumination sensor arrangement simulator 15, in response to the illumination sensor simulation starting signal, the illumination sensor installation expense, and the room/corridor information from the input module 10, calculates the number of illumination sensors to be installed on the basis of the illumination sensor installation expense and an illumination sensor unit sum, and calculates arrangement coordinates of the illumination sensors in the 2D or 3D space based on the illumination sensor installation expense. The arrangement coordinates of the illumination sensors is then transferred to the out module 19.

The occupancy sensor arrangement simulator 16, in response to the occupancy sensor simulation starting signal, the occupancy sensor installation expense, and the room/corridor information from the input module 10, calculates the number of occupancy sensors to be installed on the basis of the occupancy sensor installation expense and an occupancy sensor unit sum, and calculates arrangement coordinates of the occupancy sensors in the 2D or 3D space based on the occupancy sensor installation expense. The arrangement coordinates of the occupancy sensors is then transferred to the out module 19.

The CO₂ sensor arrangement simulator 17, in response to the CO₂ sensor simulation starting signal, the CO₂ sensor installation expense, and the room/corridor information from the input module 10, calculates the number of CO₂ sensors to be installed on the basis of the CO₂ sensor installation expense and a CO₂ sensor unit sum, and calculates CO₂ sensor arrangement coordinates of the CO₂ sensors in the 2D or 3D space based on the CO₂ sensors installation expense. The arrangement coordinates of the CO₂ sensors is then transferred to the out module 19.

The fine dust sensor arrangement simulator 18, in response to the fine dust sensor simulation starting signal, the fine dust sensor installation expense, and the room/corridor information from the input module 10, calculates the number of fine dust sensors to be installed on the basis of the fine dust sensor installation expense and a fine dust sensor unit sum, and calculates arrangement coordinates of the fine dust sensors in the 2D or 3D space based on the fine dust sensor installation expense. The arrangement coordinates of the fine dust sensors is then transferred to the out module 19.

The out module 19 receives and displays the information on the arrangement coordinates and optimal sum totals of the respective control sensors that have been calculated by their corresponding sensor arrangement simulators.

The out module 19 includes a arrangement position display unit 101, an arrangement position display unit 102 for the humidity sensors, a arrangement position display unit 103 for the temperature-humidity sensors, an arrangement position display unit 104 for the illumination sensors, an arrangement position display unit 105 for the occupancy sensors, an arrangement position display unit 106 for the CO₂ sensors, and an arrangement position display unit 107 for a fine dust sensors.

The out module 19 receives the arrangement coordinates of the temperature sensors from the temperature sensor arrangement simulator 12, receives the arrangement coordinates of the humidity sensors from the humidity sensor arrangement simulator 13, and receives the arrangement coordinates of the temperature-humidity sensors from the temperature-humidity sensor arrangement simulator 14.

Further, the out module 19 receives the arrangement coordinates of the illumination sensors from the illumination sensor arrangement simulator 15, receives the arrangement coordinates of the occupancy sensors from the occupancy sensor arrangement simulator 16, receives the arrangement coordinates of the CO₂ sensors from the CO₂ sensor arrangement simulator 17, and receives the arrangement coordinates of the fine dust sensors from the fine dust sensor arrangement simulator 18.

Subsequently, the output module 19 displays arrangement positions of the respective energy control sensors for each room and corridor of the building in the 2D or 3D space based on installation expense of the respective control sensors.

More specifically, the out module 19 displays arrangement positions of the temperature sensors for each room/corridor of the building in the 2D or 3D space, displays arrangement positions of the humidity sensors for each room/corridor of the building in the 2D or 3D space, and displays arrangement positions of the temperature-humidity sensors for each room/corridor of the building in the 2D or 3D space.

Further, the out module 19 displays arrangement positions of the illumination sensors for each room/corridor of the building in the 2D or 3D space, displays arrangement positions of the occupancy sensors for each room/corridor of the building in the 2D or 3D space, displays arrangement positions of the CO₂ sensors for each room/corridor of the building in the 2D or 3D space, and displays arrangement positions of the fine dust sensors for each room/corridor of the building in the 2D or 3D space.

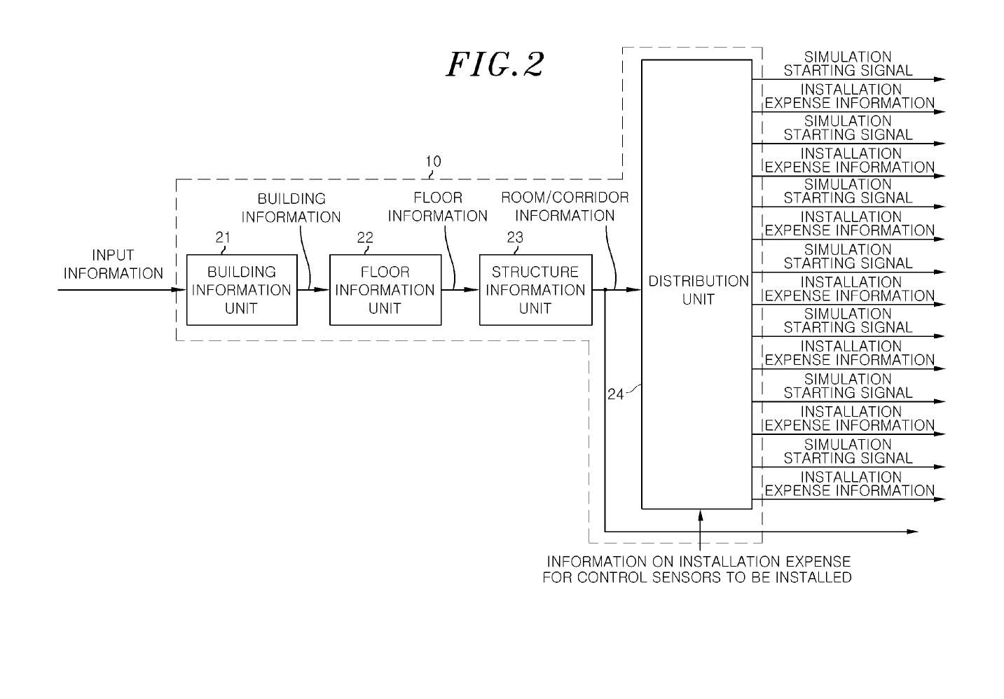

FIG. 2 illustrates a detailed block diagram of the input module 10 shown in FIG. 1A in accordance with an embodiment of the present invention. The input module 10 includes a building information unit 21, a floor information unit 22, a structure information unit 23, and a distribution unit 24.

The building information unit 21 receives the input information on the building, floors, room sizes, corridor sizes, room shapes, corridor shapes, and the installation expenses of the temperature sensors, humidity sensors, temperature-humidity sensors, illumination sensors, occupancy sensors, CO₂ sensors, and fine dust sensors from a user or a computer, stores the building information, and provides the building information to the floor information unit 22. The floor information unit 22 receives the building information from the building information unit 21, stores the floor information on the building, and provides the floor information of the building to the structure information unit 23.

The structure information unit 23 receives the floor information of the building from the floor information unit 22, stores the room and corridor information of the building and each floor thereof, and provides the room and corridor information of the building and each floor to the distribution unit 24. In addition, the room and corridor information of each floor is also provided to the temperature sensor arrangement simulator 12, the humidity sensor arrangement simulator 13, the temperature-humidity sensor arrangement simulator 14, the illumination sensor arrangement simulator 15, the occupancy sensor arrangement simulator 16, the CO₂ sensor arrangement simulator 17, and the fine dust sensor arrangement simulator 18, which will be described below.

The distribution unit 24 receives the room and corridor information from the structure information unit 23, receives the information on one or more energy control sensors to be installed in each room and corridor, and provides the respective sensor simulation starting signals and the respective sensor installation expense information to the sensor arrangement simulation module 11.

That is, the distribution unit 24 provides the temperature sensor simulation starting signal and the temperature sensor installation expense information to the temperature sensor simulator 12; the distribution unit 24 provides the humidity sensor simulation starting signal and the humidity sensor installation expense information to the humidity sensor arrangement simulator 13; provides the temperature-humidity sensor simulation starting signal AND the temperature-humidity sensor installation expense information to the temperature-humidity sensor simulator 14; and provides the illumination sensor simulation starting signal and the illumination sensor installation expense information to the illumination sensor simulator 15.

Further, the distribution unit 24 provides the occupancy sensor simulation starting signal and the occupancy sensor installation expense information to the occupancy sensor simulator 16; provides the CO₂ sensor simulation starting signal and the CO₂ sensor installation expense information to the CO₂ sensor simulator 17; and provides the fine dust sensor simulation starting signal and the fine dust sensor installation expense information to the fine dust sensor simulator 18.

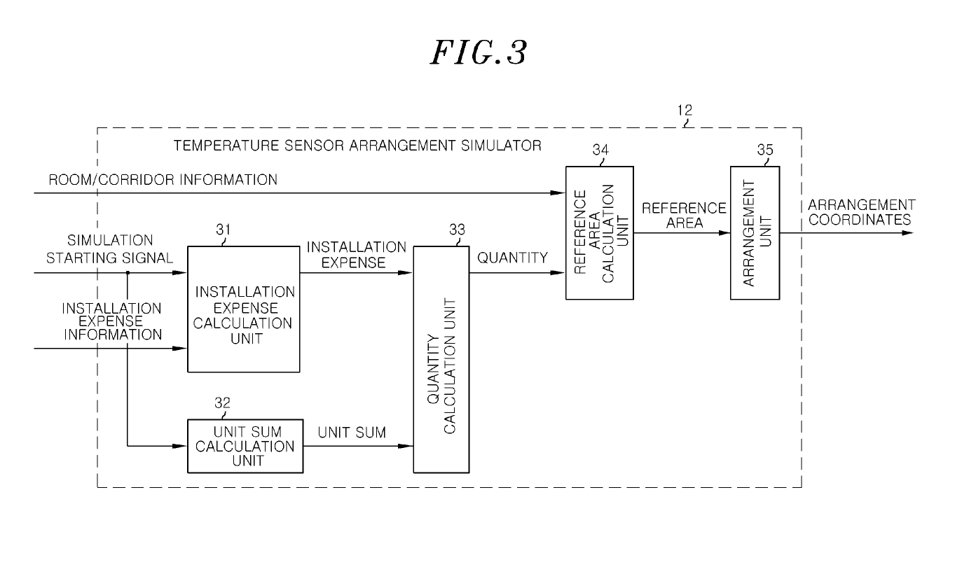

FIG. 3 illustrates a detailed block diagram of the temperature sensor arrangement simulator 12 shown in FIG. 1A. The temperature sensor arrangement simulator 12 includes an installation expense calculation unit 31, a unit sum calculation unit 32, a quantity calculation unit 33, a reference area calculation unit 34, and an arrangement unit 35.

The installation expense calculation unit 31 receives the temperature sensor simulation starting signal and the temperature-sensor installation expense information from the distribution unit 24, calculates an installation expense CPT(T) of temperature sensors in each room/corridor, and provides the calculated installation expense CPT(T) to the quantity calculation unit 33.

The unit sum calculation unit 32 receives the temperature sensor simulation starting signal from the distribution unit 24, sets a unit sum of a temperature sensor as A1 (for example, A1 is 150,000 [symbol] , and is changeable). The calculated unit sum A1 is then provided to the quantity calculation unit 33.

The quantity calculation unit 33 receives the installation expense CPT(T) from the installation expense calculation unit 31, receives the unit sum A1 from the unit sum calculation unit 32, and calculates a quantity QP(T) of the temperature sensors as expressed in Equation 1.

QP(T)=CPT(T)/A1 Eq. 1

The quantity calculation unit 33 provides the quantity QP(T) to the reference area calculation unit 34. Subsequently, the reference area calculation unit 34 receives the room/corridor information from the structure information unit 23, receives the quantity QP(T) from the quantity calculation unit 33, and calculates a reference area SP(T) as expressed in Equation 2.

SP(T)=ST/QP(T), Eq. 2

where ST is the area of a room/corridor

The reference area calculation unit 34 provides the reference area SP(T) to the arrangement unit 35. The arrangement unit 35 receives the reference area SP(T) from the reference area calculation unit 34, and calculates the arrangement positions of the temperature sensors based on the installation expense of the temperature sensor.

A horizontal position of one sensor may be set at the center of the reference area SP(T). A vertical position of one sensor may be set at the central position between a ceiling and a bottom. However, when it is unable to dispose the temperature sensors at the central position, the sensor may be disposed at the ceiling. Under such a condition, 2D/3D arrangement coordinates of the temperature sensors are calculated, and the calculated arrangement coordinates are then provided to the arrangement position display unit 101 as shown in FIG. 1B.

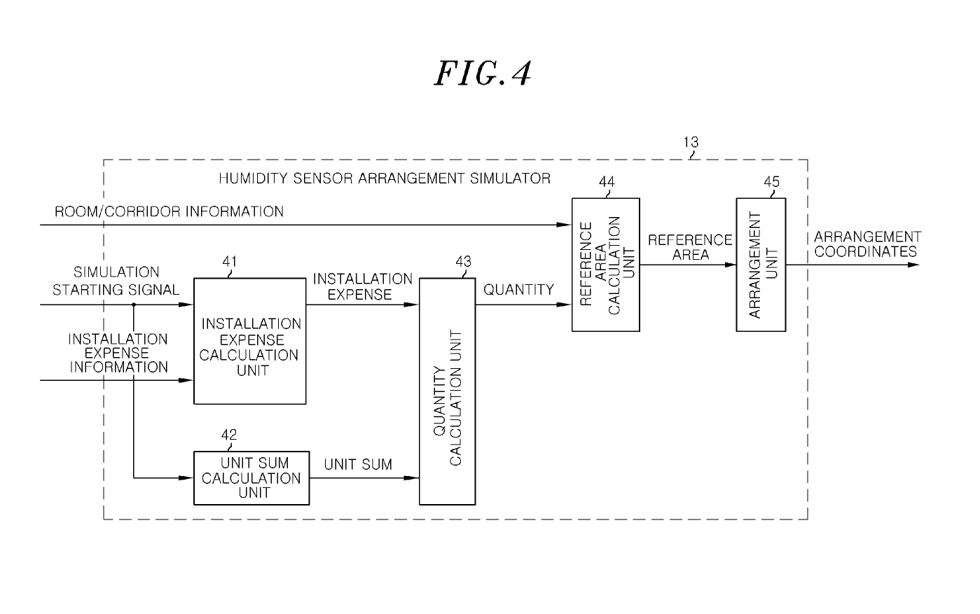

FIG. 4 illustrates a detailed block diagram of the humidity sensor arrangement simulator 13 shown in FIG. 1A. The humidity sensor arrangement simulator 12 includes an installation expense calculation unit 41, a unit sum calculation unit 42, a quantity calculation unit 43, a reference area calculation unit 44, and an arrangement unit 45.

The installation expense calculation unit 41 receives the humidity sensor simulation starting signal and the humidity sensor installation expense information from the distribution unit 24, calculates an installation expense CPT(H) of the humidity sensors to be installed in each room/corridor, and provides the calculated installation expense CPT(H) to the quantity calculation unit 43.

The unit sum calculation unit 42 receives the humidity sensor simulation starting signal from the distribution unit 24, sets a unit sum as B1 won (for example, B1 is 150000 [symbol] , and is changeable). The calculated unit sum B1 is then provided to the quantity calculation unit 43.

The quantity calculation unit 43 receives the installation expense CPT(H) from the quantity calculation unit 43, receives the unit sum B1 from the unit sum calculation unit 42, and calculates a quantity QP(H) of the humidity sensors as expressed in Equation 3.

QP(H)=CPT(H)/B1 Eq. 3

The quantity calculation unit 43 provides the quantity QP(H) of the humidity sensors to the reference area calculation unit 44. Subsequently, the reference area calculation unit 44 receives the room/corridor information from the structure information unit 23, receives the quantity QP(H) from the quantity calculation unit 43, and calculates a reference area SP(H) as expressed in Equation 4.

SP(H)=ST/QP(H), Eq. 4

where ST is the area of a room/corridor

The quantity calculation unit 43 provides the reference area SP(H) to the arrangement unit 45. The arrangement unit 45 receives the reference area SP(H) from the reference area unit 44, and calculates an arrangement position of the humidity sensors.

A horizontal position of a humidity sensor may be set at the center of the reference area SP(H). A vertical position of a humidity sensor may be set at the central position between a ceiling and a bottom. However, when it is unable to dispose the humidity sensor at the central position, the humidity sensor may be disposed at the ceiling. Under such a condition, 2D/3D arrangement coordinates of humidity sensors are calculated, and the calculated sensor 2D/3D arrangement coordinates are then provided to the arrangement position display unit 102 as shown in FIG. 1B.

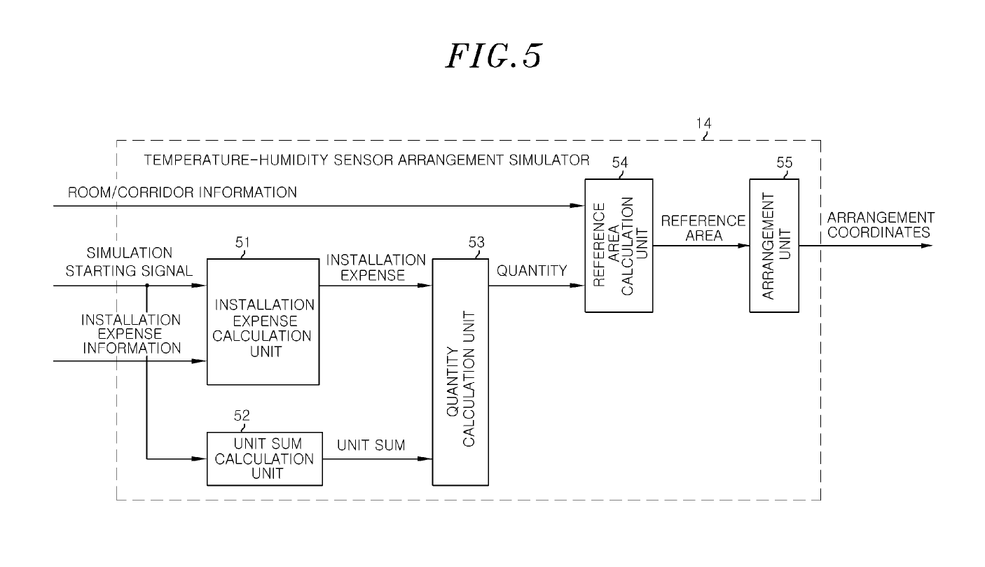

FIG. 5 illustrates a detailed block diagram of the temperature-humidity sensor arrangement simulator 14 shown in FIG. 1A. The temperature-humidity sensor arrangement simulator 14 includes an installation expense calculation unit 51, a unit sum calculation unit 52, a quantity calculation unit 53, a reference area calculation unit 54, and an arrangement unit 55.

The installation expense calculation unit 51 receives the temperature-humidity sensor simulation starting signal and the temperature-humidity sensor installation expense information from the distribution unit 24, calculates an installation expense CPT(TH) of temperature-humidity sensors in each room/corridor, and provides the calculated installation expense CPT(TH) to the quantity calculation unit 53.

The unit sum calculation unit 52 receives the temperature-humidity sensor simulation starting signal from the distribution unit 24, sets a unit sum of the temperature-humidity sensors as C1 (for example, C1 is 200000 [symbol] , and is changeable), and provides the unit sum C1 to the quantity calculation unit 53.

The quantity calculation unit 53 receives the installation expense CPT(TH) from the installation expense calculation unit 51, receives the unit sum C1 from the unit sum calculation unit 52, and calculates a quantity of temperature-humidity sensors QP(TH) as expressed in Equation 5.

QP(TH)=CPT(TH)/C1 Eq. 5

The quantity calculation unit 53 provides the quantity QP(TH) to the reference area calculation unit 54. Subsequently, the reference area calculation unit 54 receives the room/corridor information from the structure information unit 23, receives the quantity QP(TH) from the quantity calculation unit 53, and calculates a reference area SP(TH) as expressed in Equation 6.

SP(TH)=ST/QP(TH), Eq. 6

where ST is the area of a room/corridor

The quantity calculation unit 53 provides the reference area SP(TH) to the arrangement unit 55. The arrangement unit 55 receives the reference area SP(TH) from the reference area calculation unit 54, and calculates an arrangement position of the temperature-humidity sensors.

A horizontal position of a temperature-humidity sensor may be set at the center of the reference area SP(TH). A vertical position of a temperature-humidity sensor may be set at the central position between a ceiling and a bottom. However, when it is unable to dispose the sensor at the central position, the temperature-humidity sensor may be disposed at the ceiling. Under such a condition, 2D/3D arrangement coordinates of temperature-humidity sensors are calculated, and the calculated 2D/3D arrangement coordinates are then provided to the arrangement position display unit 103 as shown in FIG. 1B.

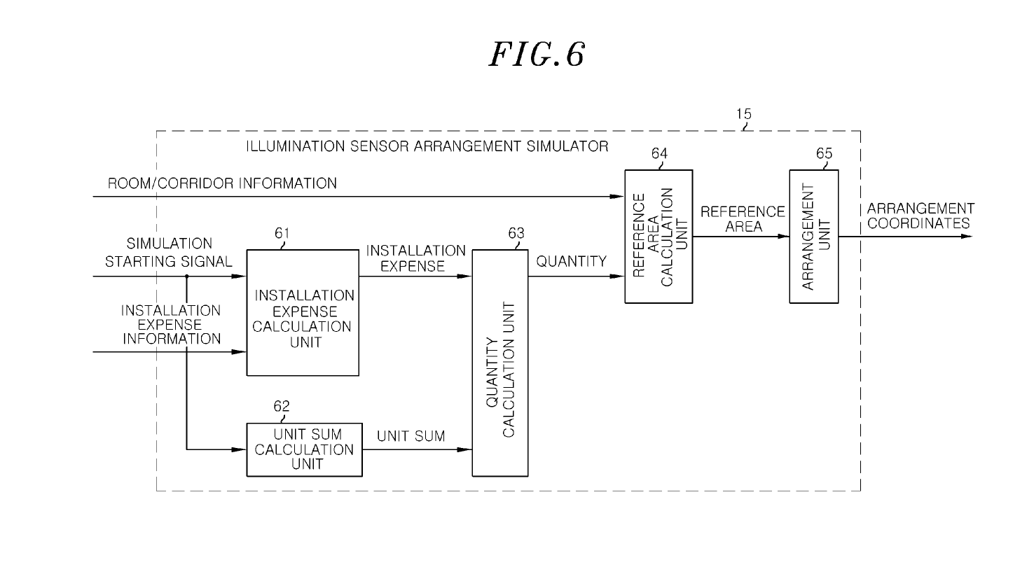

FIG. 6 illustrates a detailed block diagram of the illumination sensor arrangement simulator 15 shown in FIG. 1A. The illumination sensor arrangement simulator 15 includes an installation expense calculation unit 61, a unit sum calculation unit 62, a quantity calculation unit 63, a reference area calculation unit 64, and an arrangement unit 65.

The installation expense calculation unit 61 receives the illumination sensor simulation starting signal and the illumination sensor installation expense information from the distribution unit 24, calculates an installation expense CPT(L)″ of illumination sensors in each room/corridor, and provides the installation expense CPT(L) to the quantity calculation unit 63.

The unit sum calculation unit 62 receives the illumination sensor simulation starting signal from the distribution unit 24, sets an unit sum of illumination sensor as D1 (for example, D1 is 200000 [symbol] , and is changeable), and provides the unit sum D1 to the quantity calculation unit 63.

The quantity calculation unit 63 receives the installation expense CPT(L) from the installation expense calculation unit 61, receives the unit sum D1 from the unit sum calculation unit 62, and calculates a quantity QP(L) of illumination sensors as expressed in Equation 7.

QP(L)=CPT(L)/D1 Eq. 7

The quantity calculation unit 63 provides the quantity QP(L) to the reference area calculation unit 64. Subsequently, the reference area calculation unit 64 receives the room/corridor information from the structure information unit 23, receives the illumination-sensor installation expense based quantity QP(L) from the quantity calculation unit 63, and calculates a reference area SP(L) as expressed in Equation 8.

SP(L)=ST/QP(L), Eq. 8

where ST is the area of a room/corridor

The quantity calculation unit 63 provides the reference area SP(L) to the arrangement unit 65. The arrangement unit 65 receives the reference area SP(L) from the reference area calculation unit 64, and calculates an arrangement position of the illumination sensors.

A horizontal position of an illumination sensor may be set at the center of the illumination-sensor installation expense based reference area SP(L). A vertical position of an illumination sensor may be set at a position that is separated by 1.5 m upward from a bottom. Under such a condition, 2D/3D arrangement coordinates of illumination sensors are calculated, and the calculated 2D/3D arrangement coordinates are then provided to the arrangement position display unit 104 as shown in FIG. 1B.

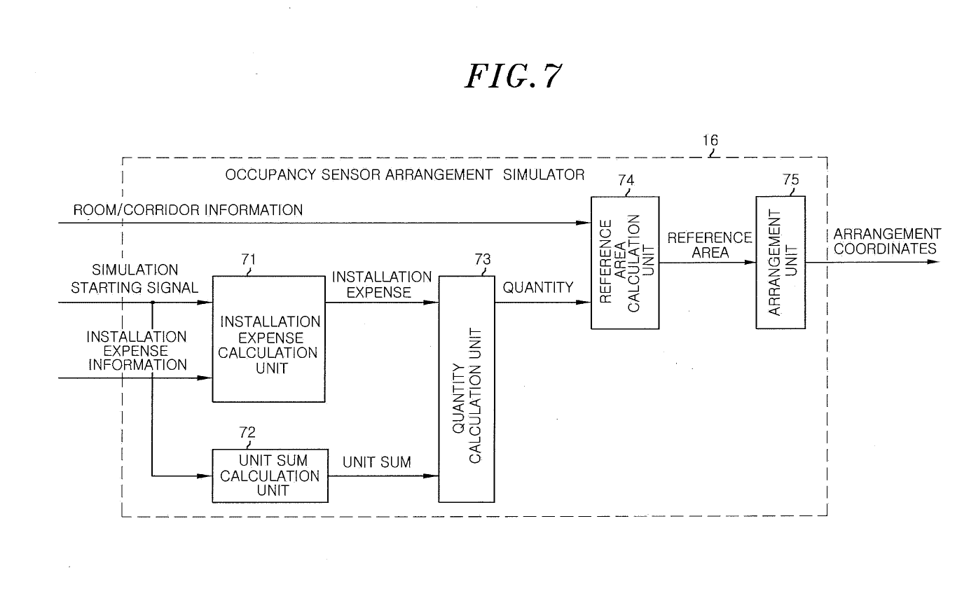

FIG. 7 illuminates a detailed block diagram of the occupancy sensor arrangement simulator 16 shown in FIG. 1A. The occupancy sensor arrangement simulator 16 includes an installation expense calculation unit 71, a unit sum calculation unit 72, a quantity calculation unit 73, a reference area calculation unit 74, and an arrangement unit 75.

The installation expense calculation unit 71 receives the occupancy sensor simulation starting signal and the occupancy sensor installation expense information from the distribution unit 24, calculates an installation expense CPT(M) of occupancy sensors in each room/corridor, and provides the calculated installation expense CPT(M) to the quantity calculation unit 73.

The unit sum calculation unit 72 receives the occupancy sensor simulation starting signal from the distribution unit 24, calculates an occupancy-sensor unit sum E1 (for example, E1 is 250000 [symbol] , and is changeable), and provides the calculated unit sum E1 to the quantity calculation unit 73.

The quantity calculation unit 73 receives the installation expense CPT(M) from the installation expense calculation unit 71, receives the unit sum E1 from the unit sum calculation unit 72, and calculates an quantity QP(M) as expressed in Equation 9.

QP(M)=CPT(M)/E1 Eq. 9

The quantity calculation unit 73 provides the quantity QP(M) of occupancy sensors to the reference area calculation unit 74. Subsequently, the reference area calculation unit 74 receives the room/corridor information from the structure information unit 23, receives the quantity QP(M) from the installation expense calculation unit 72, and calculates an reference area SP(M) as expressed in Equation 10.

SP(M)=ST/QP(M), Eq. 10

where ST is the area of a room/corridor

The reference area calculation unit 74 provides the reference area SP(M) to the arrangement unit 75. The arrangement unit 75 receives the reference area SP(M) from the reference area calculation unit 74, and calculates an arrangement position.

A horizontal position of an occupancy sensor may be set at the center of the reference area SP(M). A vertical position of an occupancy sensor may be set at a ceiling. Under such a condition, 2D/3D arrangement coordinates of occupancy sensors are calculated, and the calculated 2D/3D arrangement coordinates are then provided to the arrangement position display unit 105 as shown in FIG. 1B.

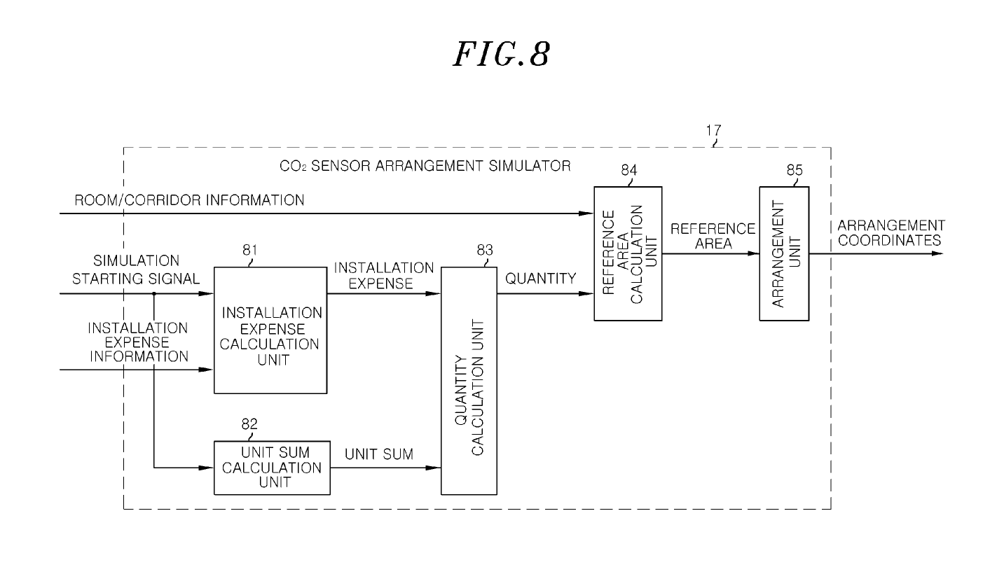

FIG. 8 illustrates a detailed block diagram of the CO₂ sensor arrangement simulator 17 shown in FIG. 1A. The CO₂ sensor arrangement simulator 17 includes an installation expense calculation unit 81, a unit sum calculation unit 82, a quantity calculation unit 83, a reference area calculation unit 84, and an arrangement unit 85.

The installation expense calculation unit 81 receives the CO₂ sensor simulation starting signal and the CO₂ sensor installation expense information from the distribution unit 24, calculates a CO₂ sensor installation expense CPT(CO₂) in each room/corridor, and provides the calculated CO₂ sensor installation expense CPT(CO₂) to the quantity calculation unit 83.

The unit sum calculation unit 82 receives the CO₂ sensor simulation starting signal from the distribution unit 24, calculates a CO₂ sensor unit sum F1 (for example, F1 is 250000 [symbol] , and is changeable), and provides the calculated CO₂ sensor unit sum F1 to the quantity calculation unit 83.

The quantity calculation unit 83 receives the CO₂ sensor installation expense CPT(CO₂) from the installation expense calculation unit 81, receives the CO₂ sensor unit sum F1 from the unit sum calculation unit 82, and calculates a quantity QP(CO₂) of CO₂ sensors as expressed in Equation 11.

QP(CO₂)=CPT(CO₂)/F1 Eq. 11

The quantity calculation unit 83 provides the calculated quantity QP(CO₂) to the reference area calculation unit 84. Subsequently, the reference area calculation unit 84 receives the room/corridor information from the structure information unit 23, receives the quantity QP(CO₂) from the quantity calculation unit 83, and calculates a reference area SP(CO₂) as expressed in Equation 12.

SP(CO₂)=ST/QP(CO₂), Eq. 12

where ST is the area of a room/corridor

The quantity calculation unit 83 provides the calculated reference area SP(CO₂) to the arrangement unit 85. The arrangement unit 85 receives the reference area SP(CO₂) from the reference area calculation unit 84, and calculates an arrangement position of CO₂ sensors based on the CO₂ sensor installation expense.

A horizontal arrangement position of a CO₂ sensor may be set at the center of the reference area SP(CO₂). A vertical arrangement position of a CO₂ sensor may be set at the central position between a ceiling and a bottom. However, when it is unable to dispose the sensor at the central position, the CO₂ sensor may be disposed at the ceiling. Under such a condition, 2D/3D arrangement coordinates of CO₂ sensors are calculated, and the calculated 2D/3D installation arrangement coordinates are then provided to the arrangement position display unit 106 as shown in FIG. 1B.

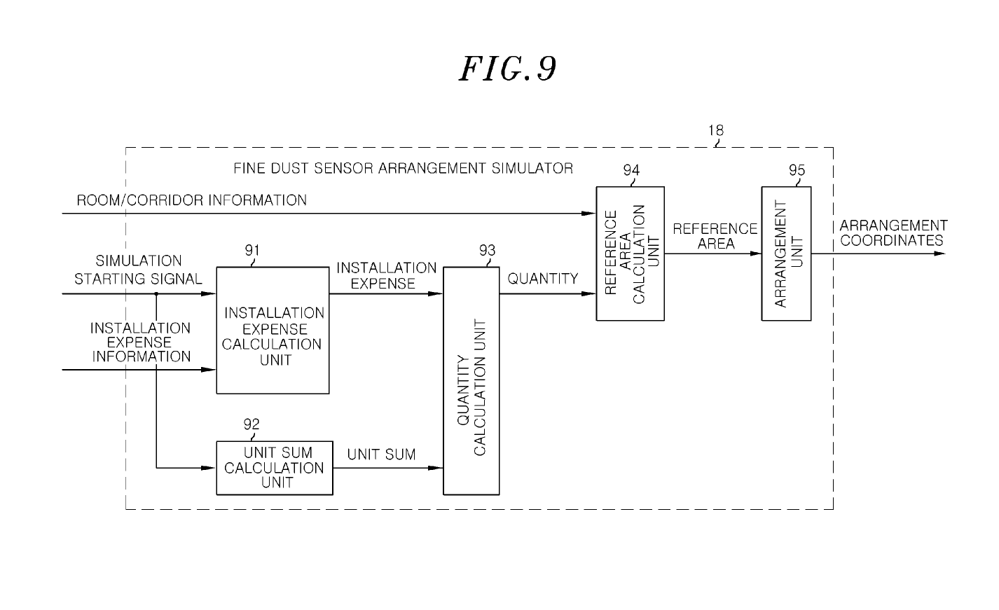

FIG. 9 illustrates a detailed block of the fine dust sensor arrangement simulator 18 shown in FIG. 1A. The fine dust sensor arrangement simulator 18 includes an installation expense calculation unit 91, a unit sum calculation unit 92, a quantity calculation unit 93, a reference area calculation unit 94, and an arrangement unit 95.

The installation expense calculation unit 91 receives the fine dust sensor simulation starting signal and the fine dust sensor installation expense information from the distribution unit 24, calculates a fine dust sensor installation expense CPT(D) in each room/corridor, and provides the calculated fine dust sensor installation expense CPT(D) to a quantity calculation unit 93.

The unit sum calculation unit 92 receives the fine dust sensor simulation starting signal from the distribution unit 24, calculates a fine dust sensor unit sum G1 (for example, G1 is 250000 [symbol] , and is changeable), and provides the fine dust sensor unit sum G1 to the quantity calculation unit 93.

The quantity calculation unit 93 receives the fine dust-sensor installation expense CPT(D) from the installation expense calculation unit 91 receives the fine dust-sensor unit sum G1 from the unit sum calculation unit 92, and calculates a fine dust sensor quantity QP(D) based on the fine dust-sensor installation expense as expressed in Equation 13.

QP(D)=CPT(D)/G1 Eq. 13

The quantity calculation unit 93 provides the fine dust sensor quantity QP(D) to the reference area calculation unit 94. Subsequently, the reference area calculation unit 94 receives the room/corridor information from the structure information unit 23, receives the fine dust sensor quantity QP(D) from the quantity calculation unit 93, and calculates a fine dust sensor reference area SP(D) based on the fine dust sensor installation expense as expressed in Equation (14).

SP(D)=ST/QP(D), Eq. 14

where ST is the area of a room/corridor

The quantity calculation unit 93 provides the fine dust sensor reference area SP(D) to the arrangement unit 85. The arrangement unit 95 receives the fine dust sensor reference area SP(D) from the reference area calculation unit 94, and calculates a fine dust sensor arrangement position based on the fine dust sensor installation expense.

A horizontal arrangement position of a fine dust sensor may be set at the center of the fine dust sensor reference area SP(D). A vertical arrangement position of a fine dust sensor may be set at the central position between a ceiling and a bottom. However, when it is unable to dispose the fine dust sensor at the central position, the fine dust sensor may be disposed at the ceiling. Under such a condition, 2D/3D arrangement coordinates of fine dust sensors are calculated, and the calculated 2D/3D arrangement coordinates are provided to the arrangement position display unit 107 as shown in FIG. 1B.

In the building energy management system, the embodiments optimally and automatically arranges and displays, in the 2D or 3D space, the temperature sensor, the humidity sensor, the temperature-humidity sensor, the illumination sensor, the occupancy sensor, the CO₂ sensor, and the fine dust sensor that are used for managing and controlling building energy and environment, on the basis of floor information of a building and structural information of rooms and corridors by floor which are provided from a user, in terms of installation expense. Accordingly, the embodiments can be applied to a wired network and a wireless network.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for automatically arranging a plurality of building energy control sensors based on installation expense, the apparatus comprising:
an input module configured to receive building information, floor information of the building, structural information of rooms and a corridor for each floor of the building, and information on installation expense for one or more energy control sensors to be installed in the building;
a sensor arrangement simulation module configured to determine arrangement coordinates of each sensor on the basis of the installation expense information for each sensors to be installed in the building; and
an out module configured to output the determined arrangement coordinates of each control sensor.

2. The apparatus of claim 1, wherein the input module comprises:
a building information unit configured to store the building information and information on sizes and shapes of the floor, room, and corridor of the building;
a floor information unit configured to store information on floors of the building;
a structure information unit configured to store information on room and corridor in each floors of the building, on the basis of the information on the floors; and
a distribution unit configured to selectively provide sensor simulation starting signals and sensor installation expense information to the sensor arrangement simulation module in response to information on one or more energy control sensors to be installed on the basis of the information, stored in the floor information unit and the structure information unit, on the floor, room, and corridor of the building, so that the sensor arrangement simulation module calculates the arrangement coordinates and installation expense based on the sensor installation expense for each energy control sensors to be installed.

3. The apparatus of claim 1, wherein the sensor arrangement simulation module comprises:
an installation expense calculation unit configured to receive a simulation starting signal to calculate installation expense of each energy control sensor to be installed, on the basis of the installation expense information for each energy control sensor;
a unit sum calculation unit configured to calculate a unit sum of each energy control sensor;
a quantity calculation unit configured to calculate a quantity of energy control sensors to be installed in the building, on the basis of the unit sum and the installation expense;
a reference area calculation unit configured to calculate a reference area of each sensor on the basis of the calculated quantity of sensors; and
an arrangement unit configured to calculate an arrangement position of each sensor, on the basis of information on the quantity of sensors and the information on the reference area.

4. The apparatus of claim 3, wherein the reference area calculation unit calculates the reference area that each sensor covers, on the basis of the information on the quantity of sensors and the area information on the room and corridor information of the building.

5. The apparatus of claim 1, wherein each of the energy control sensors comprise a temperature sensor, a humidity sensor, a temperature-humidity sensor, an illumination sensor, an occupancy sensor, a CO₂ sensor, or a fine dust sensor.

6. A method of automatically arranging a plurality of building energy control sensors based on installation expense, the method comprising:
providing building information, floor information of the building, structural information of rooms and a corridor for each floor of the building;
providing installation expense information for each sensor to be installed in the building;
calculating arrangement coordinates of each sensor on the basis of the installation expense information; and
outputting information on the calculated arrangement coordinates of each sensor in the building.

7. The method of claim 6, further comprising:
storing information on floors of the building; and
storing the structural information on sizes and shapes of the room and corridor for each floor of the building.

8. The method of claim 6, wherein said providing installation expense information comprises:
providing information on the energy control sensors to be installed in the room and corridor of each floor on the basis of the information on the floor, room, and corridor of the building; and
providing information on installation expense that is expended in installing the energy control sensors.

9. The method of claim 6, wherein said calculating arrangement coordinates comprises:
calculating, in response to a simulation starting signal, an installation expense of each sensor, on the basis of the installation expense information for each sensor;
calculating a unit sum of each sensor;
calculating quantity of sensors to be installed in the building, on the basis of the unit sum and the installation expense of each sensor;
calculating a reference area of each sensor on the basis of the calculated number of sensors; and
calculating an arrangement position of each sensor in the building, on the basis of information on the number of sensors and the information on the reference area.

10. The method of claim 9, wherein said calculating a reference area comprises calculating the reference area that each sensor covers, on the basis of the information on the quantity of sensors and the area information on the room and corridor information of the building.

11. The method of claim 6, wherein each of the energy control sensors comprise a temperature sensor, a humidity sensor, a temperature-humidity sensor, an illumination sensor, an occupancy sensor, a CO₂ sensor, or a fine dust sensor.
